(19) United States
(12) Patent Application Publication
(10) Pub. No.: US 2022/0343288 A1
(43) Pub. Date: Oct. 27, 2022

(54) COMPUTER SYSTEMS FOR DATABASE MANAGEMENT BASED ON DATA PATTERN RECOGNITION, PREDICTION AND RECOMMENDATION AND METHODS OF USE THEREOF

(71) Applicant: Capital One Services, LLC, McLean, VA (US)

(72) Inventors: Vyjayanthi Vadrevu, Pflugerville, TX (US); Amita Sharma, Potomac, MD (US); Joshua Edwards, Philadelphia, PA (US)

(21) Appl. No.: 17/236,766

(22) Filed: Apr. 21, 2021

(51) Int. Cl. G06Q 10/10; G06N 20/00; G06F 9/54

(52) U.S. Cl. CPC G06Q 10/1095; G06N 20/00; G06F 9/547

(57) ABSTRACT

Systems and methods of the present disclosure include computer processing resources to enable automated detection of recurring data records for predicting recurring and future data records including receiving a data record history comprising historical data records having a quantity attribute, a date attribute, and an entity attribute. A record pattern machine learning model engine is utilized to identify a recurring data record pattern including a cadence of recurrence for a set of recurring data records of a particular entity based on historical data records. The most recent historical data record of the recurring data records is determined and a recurrence prediction service is utilized to predict of a future data record based on the cadence and the most recent historical data record. A future data record recommendation is generated for a future action that matches the quantity attribute and of the entity attribute of the recurring data records.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in drawings that form a part of this document: Copyright, Capital One Services, LLC, All Rights Reserved.

### FIELD OF TECHNOLOGY

The present disclosure generally relates to computer-based systems for data pattern recognition, prediction and recommendation, including event prediction and event recommendation, and methods of use thereof.

### BACKGROUND OF TECHNOLOGY

Typically, database management systems receive data records, such as data records representing electronic events and/or electronic activities across computing systems, in streams or batches based upon when the data records are created. However, database management systems cannot proactively influence the creation of such data records.

### SUMMARY OF DESCRIBED SUBJECT MATTER

In some embodiments, the present disclosure provides an exemplary technically improved computer-based method that includes at least the following steps of receiving, by at least one processor, data record history including a plurality of historical data records associated with a user, where each historical data record of the plurality of historical data records includes a plurality of data attributes, including: a quantity attribute indicative of a quantity, a date attribute indicative of a date, and an entity attribute indicative of a corresponding entity; utilizing, by the at least one processor, a record pattern machine learning model engine, including a record pattern machine learning model of a plurality of trained record pattern parameters, to identify a recurring data record pattern for a particular entity in a whitelist of entities based on the plurality of trained record pattern parameters and the plurality of data attributes of the plurality of historical data records, where the entity attribute matching the particular entity in the whitelist of entities, where the recurring data record pattern includes a set of recurring data records that repeat with sporadic intervals, where the recurring data record pattern includes a cadence of recurrence of the quantity attribute and of the entity attribute of each historical data record in the set of recurring data records based on the data attribute of each historical data record in the set of recurring data records, where the cadence of recurrence predicts a regular interval based on the sporadic intervals; determining, by the at least one processor, the most recent historical data record in the set of recurring data records based on the date attribute of each historical data record in the set of recurring data records; utilizing, by the at least one processor, a recurrence prediction service, to predict of a future data record in the set of recurring data records based at least in part on the cadence of recurrence and the most recent historical data record, the future data record having a future date attribute; generating, by the at least one processor, a future data record recommendation for at least one future action having an action quantity and action entity that matches the quantity attribute and of the entity attribute of each historical data record in the set of recurring data records, where the future data record recommendation includes a future data record date associated with the future date attribute; automatically generating, by the at least one processor, a digital calendar object associated with the entity, where the digital calendar object specifies the future data record recommendation; and automatically inserting, by the at least one processor, the digital calendar object into an electronic calendar associated with the user.

In some embodiments, the present disclosure provides an exemplary technically improved computer-based system that includes at least the following components of at least one processor in communication with a non-transitory memory having software instructions stored thereon. The at least one processor is configured, upon execution of the software instructions, to perform steps to: receive a data record history including a plurality of historical data records associated with a user, where each historical data record of the plurality of historical data records includes a plurality of data attributes, including: a quantity attribute indicative of a quantity, a date attribute indicative of a date, and an entity attribute indicative of an entity; utilize a record pattern machine learning model engine, including a record pattern machine learning model of a plurality of trained record pattern parameters, to identify a recurring data record pattern for a particular entity in a whitelist of entities based on a plurality of the trained record pattern parameters and the plurality of data attributes of the plurality of historical data records, where the entity attribute matching the particular entity in the whitelist of entities, where the recurring data record pattern includes a set of recurring data records that repeat with sporadic intervals, where the recurring data record pattern includes a cadence of recurrence of the quantity attribute and of the entity attribute of each historical data record in the set of recurring data records based on the data attribute of each historical data record in the set of recurring data records, where the cadence of recurrence predicts a regular interval based on the sporadic intervals; determine the most recent historical data record in the set of recurring data records based on the date attribute of each historical data record in the set of recurring data records; utilizing a recurrence prediction service to predict a future data record in the set of recurring data records based at least in part on the cadence of recurrence and the most recent historical data record, the future data record having a future date attribute; generate a future data record recommendation for at least one future action having an action quantity and action entity that matches the quantity attribute and of the entity attribute of each historical data record in the set of recurring data records, where the future data record recommendation includes a future data record date associated with the future date attribute; automatically generate an electronic event object associated with the entity, where the electronic event object specifies a future data record for the user according to the future data record recommendation; and automatically inserting, by the at least one processor, the digital calendar object into an electronic calendar associated with the user.

Embodiments of the present disclosure further include the systems and methods as described above where the plurality of data attributes further include a time of day attribute indicative of a time of day, where the recurring data record pattern further includes a time of day pattern based on the time of day attribute of each historical data record in the set of recurring data records.

Embodiments of the present disclosure further include the systems and methods as described above further including: determining, by the at least one processor, an activity associated with each historical data record in the set of recurring data records; determining, by the at least one processor, an activity length based on the activity; and determining, by the at least one processor, a scheduled time estimate associated with the set of recurring data records based on the activity length and the time of day pattern.

Embodiments of the present disclosure further include the systems and methods as described above further including determining, by the at least one processor, an future data record time for the future data record recommendation based on the scheduled time estimate.

Embodiments of the present disclosure further include the systems and methods as described above further including: determining, by the at least one processor, a contact method associated with the entity of the entity attribute of each historical data record in the set of recurring data records; and automatically generating, by the at least one processor, a future data record request via the contact method based on the future data record recommendation.

Embodiments of the present disclosure further include the systems and methods as described above where the contact method includes at least one of: i) a text message, ii) a telephone call, iii) an email, or iv) a combination thereof.

Embodiments of the present disclosure further include the systems and methods as described above further including: determining, by the at least one processor, a future data record application programming interface (API) associated with the entity of the entity attribute of each historical data record in the set of recurring data records, where the future data record API enables an automated electronic future data record entry with the entity; and automatically generating, by the at least one processor, a future data record API request via the future data record API based on the future data record recommendation.

Embodiments of the present disclosure further include the systems and methods as described above where the plurality of historical data records include a history of payment authorizations.

Embodiments of the present disclosure further include the systems and methods as described above where the set of recurring data records include recurring service transactions.

Embodiments of the present disclosure further include the systems and methods as described above where the future data record recommendation includes a service future data record for a future service transaction of the recurring service transactions.

### BRIEF DESCRIPTION OF THE DRAWINGS

Various embodiments of the present disclosure can be further explained with reference to the attached drawings, wherein like structures are referred to by like numerals throughout the several views. The drawings shown are not necessarily to scale, with emphasis instead generally being placed upon illustrating the principles of the present disclosure. Therefore, specific structural and functional details disclosed herein are not to be interpreted as limiting, but merely as a representative basis for teaching one skilled in the art to variously employ one or more illustrative embodiments.

FIGS. 1-7 show one or more schematic flow diagrams, certain computer-based architectures, and/or screenshots of various specialized graphical user interfaces which are illustrative of some exemplary aspects of at least some embodiments of the present disclosure.

### DETAILED DESCRIPTION

Various detailed embodiments of the present disclosure, taken in conjunction with the accompanying figures, are disclosed herein; however, it is to be understood that the disclosed embodiments are merely illustrative. In addition, each of the examples given in connection with the various embodiments of the present disclosure is intended to be illustrative, and not restrictive.

Throughout the specification, the following terms take the meanings explicitly associated herein, unless the context clearly dictates otherwise. The phrases “in one embodiment” and “in some embodiments” as used herein do not necessarily refer to the same embodiment(s), though it may. Furthermore, the phrases “in another embodiment” and “in some other embodiments” as used herein do not necessarily refer to a different embodiment, although it may. Thus, as described below, various embodiments may be readily combined, without departing from the scope or spirit of the present disclosure.

In addition, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the terms “and” and “or” may be used interchangeably to refer to a set of items in both the conjunctive and disjunctive in order to encompass the full description of combinations and alternatives of the items. By way of example, a set of items may be listed with the disjunctive “or”, or with the conjunction “and.” In either case, the set is to be interpreted as meaning each of the items singularly as alternatives, as well as any combination of the listed items.

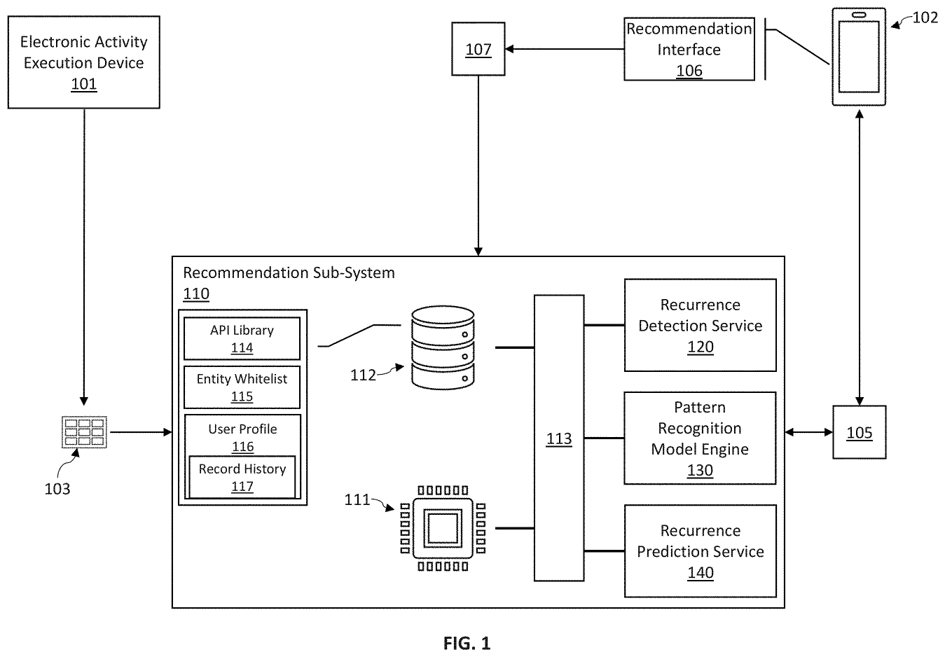

FIGS. 1 through 7 illustrate systems and methods of data record pattern recognition for proactive prediction and recommendation of data record scheduling and creation. The following embodiments provide technical solutions and technical improvements that overcome technical problems, drawbacks and/or deficiencies in the technical fields involving database management and electronic event scheduling. As explained in more detail, below, technical solutions and technical improvements herein include aspects of improved pattern recognition of the time-dependent creation and receipt of data records for improved prediction and recommendation of future data record creation for improved database management and electronic event schedule technologies. Based on such technical features, further technical benefits become available to users and operators of these systems and methods. Moreover, various practical applications of the disclosed technology are also described, which provide further practical benefits to users and operators that are also new and useful improvements in the art.

FIG. 1 is a block diagram of an exemplary computer-based system for the automated detection of recurring data records for predicting recurring and future data records in accordance with one or more embodiments of the present disclosure.

In some embodiments, a user may engage in electronic activities across computer networks. In some embodiments, the electronic activities may be executed in cooperation or association with other entities using electronic activity execution devices 101.

In some embodiments, an electronic activity data record may include, e.g., a user identifier associated with each data record, a entity identifier associated with each data record, an activity type identifier, an activity value or activity quantity, a time data item, a location data item, a date data item, a device type or device identifier associated with the electronic electronic activity execution device 101, an activity description, or other attributes representing characteristics of each data record.

For example, in some embodiments, the electronic activity data record may include a transaction-related activity, such as a transaction record (e.g., transaction authorization request, posted transaction, etc.). In such an example, the data items may include, e.g., a transaction value, a transaction type, an account identifier or a user identifier or both, a merchant identifier, a transaction authorization date, a transaction post date, a transaction location, an execution device (e.g., point-of-sale device, Internet payment, etc.) among other transaction data and combinations thereof.

In some embodiments, the electronic activity execution device may include any computing device from electronic activities are performed or executed, such as, e.g., a terminal, personal computer or mobile computing device for performing Internet-based and application-based activities (e.g., account logins, account information changes, online purchases, instant message communications, social media posts, among others and combinations thereof).

In some embodiments, the electronic activity execution device may include a physical terminal for performing electronic transactions, such as, e.g., a point-of-sale device, automated teller machine (ATM) or other device. As a result of a user executing electronic activities via the electronic activity execution device, data records may be produced for entry into the user profile 116. For example, the electronic activity execution device may produce an electronic activity data record.

In some embodiments, as a result of executing the electronic activities, an electronic electronic activity execution device 101 may produce data records 103 representative of the electronic activities. In some embodiments, the electronic activities can include recurring events, relationships, or other recurring activity-related characteristics. Such recurring electronic activities result in recurring data records. Typically, such recurring data records are treated as any other data record. However, in some embodiments, the recommendation sub-system 110 leverages pattern recognition of the recurring data records to formulate recommendations and forecasts of future data records and events associated therewith for improved efficiency in processing the future data records for scheduling of operations, security analysis, and other data record processing operations.

Accordingly, in some embodiments, the recommendation sub-system 110 may receive the historical data records to recognize recurring data records and patterns of recurrence, including a cadence of recurrence. In some embodiments, based on the recognition of the patterns of recurrence for recurring data records, the recommendation sub-system 110 may interface with a computing device 102 to enable user interaction via a recommendation interface 106 for providing recommendations regarding the recurring patterns of recurring data records and enabling user feedback 107 via selection of acceptance, rejection and modification of the recommendations, the recognized recurring patterns, among other actions. Thus, in some embodiments, the recommendation sub-system 110 may utilize pattern recognition as well as user feedback to anticipate future data records for resource scheduling, recommend future electronic activities based on user behaviors, and improve security according to deviations from the recognized patterns for recurring data records.

In some embodiments, the recommendation sub-system 110 may be a part of the computing device 102. Thus, the recommendation sub-system 110 may include hardware and software components including, e.g., computing device 102 hardware and software, cloud or server hardware and software, or a combination thereof.

In some embodiments, the recommendation sub-system 110 may include hardware components such as a processor 111 for effectuating functionality via the execution of software instruction from a non-transitory computer readable medium that stores the software instruction thereon. In some embodiments, the processor 111 may include local or remote processing components. In some embodiments, the processor 111 may include any type of data processing capacity, such as a hardware logic circuit, for example an application specific integrated circuit (ASIC) and a programmable logic, or such as a computing device, for example, a microcomputer or microcontroller that include a programmable microprocessor. In some embodiments, the processor 111 may include data-processing capacity provided by the microprocessor. In some embodiments, the microprocessor may include memory, processing, interface resources, controllers, and counters. In some embodiments, the microprocessor may also include one or more programs stored in memory.

Similarly, the recommendation sub-system 110 may include storage 112, such as local hard-drive, solid-state drive, flash drive, database or other local storage, or remote storage such as a server, mainframe, database or cloud provided storage solution, or any other suitable non-transitory computer readable medium. In some embodiments, the term “database” refers to an organized collection of data, stored, accessed or both electronically from a computer system. The database may include a database model formed by one or more formal design and modeling techniques. The database model may include, e.g., a navigational database, a hierarchical database, a network database, a graph database, an object database, a relational database, an object-relational database, an entity-relationship database, an enhanced entity-relationship database, a document database, an entity-attribute-value database, a star schema database, or any other suitable database model and combinations thereof. For example, the database may include database technology such as, e.g., a centralized or distributed database, cloud storage platform, decentralized system, server or server system, among other storage systems. In some embodiments, the database may, additionally or alternatively, include one or more data storage devices such as, e.g., a hard drive, solid-state drive, flash drive, or other suitable storage device. In some embodiments, the database may, additionally or alternatively, include one or more temporary storage devices such as, e.g., a random-access memory, cache, buffer, or other suitable memory device, or any other data storage solution and combinations thereof.

Depending on the database model, one or more database query languages may be employed to retrieve data from the database. Examples of database query languages may include: JSONiq, LDAP, Object Query Language (OQL), Object Constraint Language (OCL), PTXL, QUEL, SPARQL, SQL, XQuery, Cypher, DMX, FQL, Contextual Query Language (CQL), AQL, among suitable database query languages.

The database may include one or more software, one or more hardware, or a combination of one or more software and one or more hardware components forming a database management system (DBMS) that interacts with users, applications, and the database itself to capture and analyze the data. The DBMS software additionally encompasses the core facilities provided to administer the database. The combination of the database, the DBMS and the associated applications may be referred to as a “database system”.

In some embodiments, the recommendation sub-system 110 may implement computer engines for identifying recurring data records, pattern recognition for identifying a cadence of recurrence and recommendation generation for recommendations based on forecasted future data records. In some embodiments, the terms “computer engine” and “engine” identify at least one software component and/or a combination of at least one software component and at least one hardware component which are designed/programmed/configured to manage/control other software and/or hardware components (such as the libraries, software development kits (SDKs), objects, etc.).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

In some embodiments, to determine the errors, the recommendation sub-system 110 may include computer engines including, e.g., a recurrence detection service 120. In some embodiments, the recurrence detection service 120 may analyze record histories 117 of each user profile 116 to identify whether data records 103 are part of a recurring series of data records associated with recurring electronic activities. In order to implement the recurrence detection service 120, the recurrence detection service 120 may include software components, hardware components, or a combination thereof. For example, each computer engine may include a dedicated processor and storage. However, in some embodiments, the computer engines share hardware resources, including the processor 111 and storage 112 of the recommendation sub-system 110 via, e.g., a bus 113. Thus, the recurrence detection service 120 may include a memory including software and software instructions, such as, e.g. machine learning models and/or logic for identifying recurring data records according to data attributes that are common to each data record in the recurring data records.

In some embodiments, to determine the errors, the recommendation sub-system 110 may include computer engines including, e.g., a pattern recognition model engine 130. In some embodiments, the pattern recognition model engine 130 may analyze each data record in an identified series or set of recurring data records to determine a pattern of recurrence of the recurring data records associated with recurring electronic activities. In order to implement the pattern recognition model engine 130, the pattern recognition model engine 130 may include software components, hardware components, or a combination thereof. For example, each computer engine may include a dedicated processor and storage. However, in some embodiments, the computer engines share hardware resources, including the processor 111 and storage 112 of the recommendation sub-system 110 via, e.g., a bus 113. Thus, the pattern recognition model engine 130 may include a memory including software and software instructions, such as, e.g. machine learning models and/or logic for recognizing a pattern including a cadence of recurrence of data records in an identified series of recurring data records according to data attributes of each data record in the recurring data records.

In some embodiments, to determine the errors, the recommendation sub-system 110 may include computer engines including, e.g., a recurrence prediction service 140. In some embodiments, the recurrence prediction service 140 may utilize the data attributes common to each data record in the identified recurring data records and the pattern of recurrence to forecast a future data record and a future electronic activity associated therewith to produce a recommendation. In order to implement the recurrence prediction service 140, the recurrence prediction service 140 may include software components, hardware components, or a combination thereof. For example, each computer engine may include a dedicated processor and storage. However, in some embodiments, the computer engines share hardware resources, including the processor 111 and storage 112 of the recommendation sub-system 110 via, e.g., a bus 113. Thus, the recurrence prediction service 140 may include a memory including software and software instructions, such as, e.g. machine learning models and/or logic for forecasting the future data record based on the data attributes of the data records in the recurring data records and the pattern of recurrence.

In some embodiments, to identify the recurring data records, the recommendation sub-system 110 may receive the historical data records and enter the historical data records into a record history 117 of an associated user profile 116 of a user associated with the historical data records. In some embodiments, to match the data record 103 to user profile 116, the recommendation sub-system 110 may compare a user identifier or account identifier to user identifiers or account identifiers of user profiles 116, e.g., in the storage 112. Using, e.g., an index or database query or other method of searching the storage 112, the recurrence detection service 120 may access the associated user profile 116 to access data records for the user, including, e.g., a record history 117. In some embodiments, the record history 117 may include historical data records for electronic activities associated with the account.

Accordingly, in some embodiments, the recommendation sub-system 110 may receive the data record 103 for recordation in the record history 117 of the user profile 116. In some embodiments, recording the data record 103 enables comparison of attributes and characteristics to filter parameters in order to determine whether the data record 103 is a part of a set of recurring data records.

Accordingly, the recommendation sub-system 110 may maintain a log of historical data records, including the data record 103, recording electronic activities associated with user of the user profile 116. In some embodiments, each historical data record in the record history 117 may have data attributes including, e.g., a user identifier associated with each historical data record, a entity identifier associated with each historical data record, an activity type identifier, an value or quantity attribute indicative of a quantity associated with the execution of the electronic activity, a time attribute indicative of a time associated with the execution of the electronic activity (such as a time of day), a location attribute indicative of a location associated with the execution of the electronic activity, a date attribute indicative of a date associated with the execution of the electronic activity, a device type or device identifier associated with the electronic activity execution device 101, an activity description, or other data items representing characteristics of each historical data record. In some embodiments, the electronic activities may include routinely or regularly performed electronic activities. Accordingly, some or all of the historical data records in the record history 117 may include regularly repeating or recurring data attributes indicative of a recurring electronic activity.

For example, in some embodiments, the historical data records may include transaction-related activity, such as a transaction record (e.g., transaction authorization request, posted transaction, etc.). In such an example, the data items may include, e.g., a transaction value, a transaction type, an account identifier or a user identifier or both, a merchant identifier, a transaction authorization date, a transaction post date, a transaction location, among other transaction data. Accordingly, the record history 117 of a user profile 116 may include a transaction history of records of transactions that the user participated in. For example, one or more of the transaction records may pertain to services purchased, such as, e.g., personal hygiene services (e.g., haircuts, massages, pedicures, manicures, etc.), health services (e.g., physicals, dentist appointments, physical therapy, etc.), automotive and home services (e.g., oil changes, heating oil purchases, and other routine maintenance services), among other routine services.

In some embodiments, the recurrence detection service 120 may examine attributes of each historical data record to determine whether it is a candidate recurring data record. In some embodiments, recurring data records may have a set of attributes that conform to particular behaviors indicative of a recurring electronic activity. For example, each data record in a set of recurring data records may have repeating attributes, such as a common entity attribute, a common quantity attribute, a common value attribute, a common location attribute, among other attributes common to all data records in a set of recurring data record. Thus, in some embodiments, the recurrence detection service 120 may extract, e.g., the entity attribute, quantity attribute, location attribute, or a combination thereof, and compare the attribute or attributes to the correspond attributes of each data record in the record history 117. In some embodiments, the comparison may identify a set of candidate recurring data records that have matching entity attributes, quantity attributes and/or location attributes to each historical data record. The set of candidate recurring data records indicate that the electronic activities associated therewith have a common quantity, entity and location, thus indicating a potentially recurring electronic activities with the entity at the location for the quantity. For example, transaction records identifying a common merchant at a common location for a common monetary value (pricing) may suggest that the user transacts with the merchant at the location for a similar transaction on a repeating basis.

In some embodiments, the recurrence detection service 120 may instead or in addition employ a record pattern model to identify whether each historical data record is in a set of candidate recurring data records. For example, in some embodiments, a classification model may be employed to correlate attributes of each historical data record to a classification as a recurring or not a recurring. In some embodiments, the classification model may utilize one or more exemplary AI/machine learning techniques chosen from, but not limited to, decision trees, boosting, support-vector machines, neural networks, nearest neighbor algorithms, Naive Bayes, bagging, random forests, and the like. In some embodiments and, optionally, in combination of any embodiment described above or below, an exemplary neural network technique may be one of, without limitation, feedforward neural network, radial basis function network, recurrent neural network, convolutional network (e.g., U-net) or other suitable network. In some embodiments and, optionally, in combination of any embodiment described above or below, an exemplary implementation of Neural Network may be executed as follows:

i) Define Neural Network architecture/model,

ii) Transfer the input data to the exemplary neural network model,

iii) Train the exemplary model incrementally,

iv) determine the accuracy for a specific number of timesteps,

v) apply the exemplary trained model to process the newly-received input data,

vi) optionally and in parallel, continue to train the exemplary trained model with a predetermined periodicity.

In some embodiments and, optionally, in combination of any embodiment described above or below, the exemplary trained neural network model may specify a neural network by at least a neural network topology, a series of activation functions, and connection weights. For example, the topology of a neural network may include a configuration of nodes of the neural network and connections between such nodes. In some embodiments and, optionally, in combination of any embodiment described above or below, the exemplary trained neural network model may also be specified to include other parameters, including but not limited to, bias values/functions and/or aggregation functions. For example, an activation function of a node may be a step function, sine function, continuous or piecewise linear function, sigmoid function, hyperbolic tangent function, or other type of mathematical function that represents a threshold at which the node is activated. In some embodiments and, optionally, in combination of any embodiment described above or below, the exemplary aggregation function may be a mathematical function that combines (e.g., sum, product, etc.) input signals to the node. In some embodiments and, optionally, in combination of any embodiment described above or below, an output of the exemplary aggregation function may be used as input to the exemplary activation function. In some embodiments and, optionally, in combination of any embodiment described above or below, the bias may be a constant value or function that may be used by the aggregation function and/or the activation function to make the node more or less likely to be activated.

In some embodiments, the set of candidate recurring data records may indicate possible recurring electronic activities. However, the possible recurring electronic activities may or may not be recurring electronic activities. Indeed, it is possible that the electronic activities associated with the data records of the set of candidate recurring data records may be similar but different activities, such as, e.g., recurring grocery store purchases instead of recurring scheduled service appointments, or other example of recurring electronic activities. Accordingly, in some embodiments, the recurrence detection service 120 may also compare an entity identifier of each historical data record to an entity whitelist 115 for whom recurring data records are recognized to occur. In some embodiments, where the entity identifier identifies an entity in the entity whitelist 115, the recurrence detection service 120 may identify each historical data record as a candidate recurring data record.

Thus, the recurrence detection service 120 may generate a set of candidate recurring data records by determining an electronic activity associated with each data record according to, e.g., the entity identifier, quantity attribute, and/or location attribute. Based on the activity, the recurrence detection service 120 may determine an estimated activity length, such as how long the activity takes to execute. In some embodiments, the estimate activity length may be based on an activity length machine learning model trained against attributes of recurring data records, or based on an index, look-up-table or other reference correlating activity attributes of various electronic activities to estimate activity lengths.

In some embodiments, using the estimated activity length, the recurrence detection service 120 may determine a start time of the electronic activity associated with the data records in the set of candidate recurring data records. To do so, the recurrence detection service 120 may assume the time attribute of each data record to indicate a time of completion of the electronic activity. Thus, by subtracting the estimated length from each time attribute, a scheduled time estimate for each data record in the set of candidate recurring data records may be determined. In some embodiments, the time attribute may instead be a beginning of the electronic activities, in which case the scheduled time estimate may be determined as the time attribute.

For example, where the electronic activity relates to a service transaction, the estimated activity time may be determined for the type of service transaction, where the type of service transaction is identified based on, e.g., the merchant and the transaction amount. Thus, the start of the service for the service transaction may be determined as the estimated length of a service of the type of service transaction subtracted from the time of the transaction record.

As a result, in some embodiments, the recurrence detection service 120 may identify a set of data records that are candidates as recurring data records associated with a recurring electronic activity. The recurrence detection service 120 may determine for the set the activity and the activity length for the data records of the set of candidate recurring data records, and the scheduled time estimate for each data record in the set based on the activity length and the time of each data record in the set to output a pattern of the time of day associated with each data record in the set of candidate data records. In some embodiments, the time of day as identified according to activity length and time attributes may be sporadic, e.g., occurring irregularly or semi-regularly during a day of each data record.

In some embodiments, to ensure that the data attributes of the data records in the set of candidate recurring data records are correct, the recurrence detection service 120 may extract the common data attributes and provide them to the recommendation interface 106 of the computing device 102. In some embodiments, the recommendation interface 106 may include interface elements enabling the user to accept, reject or modify the data attributes. Accordingly, the recurrence detection service 120 may verify the set of candidate recurring data records by requesting whether any information is missing or wrong. The user selections in response may be used to correct the common data attributes for user by the pattern recognition model engine 130.

In some embodiments, to determine whether the cadence of recurrence of the data records in the set of candidate recurring data records and whether the time of day pattern indicate a set of recurring data records for an entity in the entity whitelist 115, the pattern recognition model engine 130 may ingest the set of candidate data records and the time of day pattern to determine a recurring data record pattern.

In some embodiments, the record pattern model may include record pattern parameters trained against known recurring data records using attributes such as, e.g., a user identifier associated with each data record, an entity identifier associated with each data record, an activity type identifier, an activity value or activity quantity attribute, a time of day attribute, a location attribute, a date attribute, a device type or device identifier associated with the electronic activity execution device, or other attributes as input features. Based on an error in predicting the classification of the known recurring data records, the record pattern model may be trained to automatically recognize a recurring data record pattern for sets of candidate recurring data records that are recurring data records.

In some embodiments, the pattern recognition model engine 130 may be configured to utilize the record pattern model including, e.g., decision trees, boosting, support-vector machines, neural networks, nearest neighbor algorithms, Naive Bayes, bagging, random forests, and the like. In some embodiments and, optionally, in combination of any embodiment described above or below, an exemplary neural network technique may be one of, without limitation, feedforward neural network, radial basis function network, recurrent neural network, convolutional network (e.g., U-net) or other suitable network. In some embodiments and, optionally, in combination of any embodiment described above or below, an exemplary implementation of Neural Network may be executed as follows:

i) Define Neural Network architecture/model,

ii) Transfer the input data to the exemplary neural network model,

iii) Train the exemplary model incrementally,

iv) determine the accuracy for a specific number of timesteps,

v) apply the exemplary trained model to process the newly-received input data,

vi) optionally and in parallel, continue to train the exemplary trained model with a predetermined periodicity.

In some embodiments and, optionally, in combination of any embodiment described above or below, the exemplary trained neural network model may specify a neural network by at least a neural network topology, a series of activation functions, and connection weights. For example, the topology of a neural network may include a configuration of nodes of the neural network and connections between such nodes. In some embodiments and, optionally, in combination of any embodiment described above or below, the exemplary trained neural network model may also be specified to include other parameters, including but not limited to, bias values/functions and/or aggregation functions. For example, an activation function of a node may be a step function, sine function, continuous or piecewise linear function, sigmoid function, hyperbolic tangent function, or other type of mathematical function that represents a threshold at which the node is activated. In some embodiments and, optionally, in combination of any embodiment described above or below, the exemplary aggregation function may be a mathematical function that combines (e.g., sum, product, etc.) input signals to the node. In some embodiments and, optionally, in combination of any embodiment described above or below, an output of the exemplary aggregation function may be used as input to the exemplary activation function. In some embodiments and, optionally, in combination of any embodiment described above or below, the bias may be a constant value or function that may be used by the aggregation function and/or the activation function to make the node more or less likely to be activated.

In some embodiments, the pattern recognition model engine 130 enables a flexibility to pattern recognition that needs less efficient algorithms in logic-based algorithms because the set of candidate recurring data records may be recurring data records that occur on a sporadic cadence. For example, the data records may occur every interval length such as every, e.g., week, two weeks, three weeks, four weeks, month, two months, three months, five months, or multiples thereof. In some embodiments, the interval length may be imprecise, e.g., sporadic, such as recurring every, e.g., between 5 and 10 days, between 10 and 17 days, between 17 and 24 days, between 25 and 35 days, or other sporadic interval length within one, two, three, four, five or six days of a regular interval length. The use of the machine learning model enables recognition of a most likely interval length where the interval lengths between each data record is not exactly regular.

In some embodiments, the prediction by the pattern recognition model engine 130 may include a predicted recurring data record pattern. In some embodiments, the recurring data record pattern may include cadence of recurrence of the electronic activity according to a predicted interval length. For example, the cadence may include, e.g., one week, two weeks, three weeks, four weeks, one month, two months, three months, four months, six months, one year or combinations and multiples thereof. In some embodiments, the predicted recurring data record pattern may also include a prediction for a time of day, such as, e.g., a time of day or a range of times of day within which the future data record is predicted to occur.

In some embodiments, the prediction may be used to forecast a future data record associated with a future electronic activity in the recurring data records. Accordingly, the recurrence prediction service 140 may predict the next data record based on the data attributes of the data records in the set of recurring data records and the recurring data record pattern.

In some embodiments, the recurrence prediction service 140 may check the date attributes of each data record in the set of recurring data records to identify a most recent data record. By adding the cadence of the prediction to the date attribute of the most recent data record, the recurrence prediction service 140 may determine a date attribute for the future data record. In some embodiments, the recurrence prediction service 140 may generate the prediction for the future data record using the prediction of the data attribute and the common data attributes common to the data records in the set of recurring data records.

In some embodiments, the recurrence prediction service 140 may also determine a time of day of the future data record. While the pattern recognition model engine 130 may generate a prediction of the time of day as part of the prediction for the recurring data record pattern, the recurrence prediction service 140 may instead or in addition determine an estimate of the time of day. For example, the recurrence prediction service 140 may extract the time of day attributes from each data record in the set of recurring data records and determine a statistical value indicative of a most likely or most common time of day associated with the electronic activity. For example, the recurrence prediction service 140 may determine, e.g., an average, a median, a range, a standard deviation, a date-dependent linear regression, a day of the week-dependent linear regression, or other statistical analysis of the times of day of each data record and combinations thereof. Accordingly, the recurrence prediction service 140 may predict a schedule time estimate for a time of day attribute of the future data record indicative of an estimated scheduled time for the future electronic activity.

In some embodiments, based on the prediction of the future data record and associated data attributes, the recurrence prediction service 140 may generate a future data record recommendation 105. In some embodiments, the future data record recommendation 105 may include, e.g., a recommendation to a user for a time and date of a future electronic activity according to the data attributes of the prediction for the future data record. For example, the future data record recommendation 105 may include, e.g., a recommended date and time of day, a recommended activity quantity, a recommended location, among other attributes to plan, schedule, or otherwise prepare for the future electronic activity. For example, resources, including computational resources may be scheduled for executing and processing the future electronic activity, security and fraud checks can be updated to expect the future data record, and the user may schedule or book the future electronic activity. For example, for a service transaction, fraud checks may be updated to expect the transaction authorization request of the future service transaction for more efficient and secure fraud checking, and the user may schedule the appointment for the future service transaction.

In some embodiments, upon prediction of the future data record recommendation 105, the recommendation sub-system 110 may notify a user of the future data record recommendation 105, e.g., via a computing device 102. In some embodiments, the computing device 102 may be any suitable computing device, such as, e.g., a laptop computer, desktop computer, tablet, smartphone, smartwatch, or other computing device including mobile devices, wearables, et cetera. In some embodiments, the notification may include utilizing the user's contact information to identify and communicate with the computing device 102. For example, the user may have specified a contact method for the recommendation sub-system 110, and may have specified contact methods for particular entities of data records, such as the entity of the data records in the set of recurring data records.

In some embodiments, using the contact method, the recommendation sub-system 110 may notify the user via the recommendation interface 106 of the future data record recommendation 105. In some embodiments, the recommendation sub-system 110 may generate the notification including the prediction of the future data record recommendation 105 to deliver to the computing device 102. For example, the notification may include, e.g., a telephone call (e.g., automated voice call or in-person telephone call), an email, a simple message service (SMS) message, a multi-media message service (MMS) message, a rich communication service (RCS) message, an internet messaging message (e.g., Apple iMessage, WhatsApp, Facebook Messenger, Signal, Telegram, Skype, or other internet-based messaging service), social media message, telephone call, or any other suitable messaging technique. In some embodiments, the notification may be an application notification, such as, e.g., a push notification from an application associated with the recommendation sub-system 110 (e.g., a banking application, social media application, or other suitable application). Therefore, the computing device 102 may be configured to produce a recommendation interface 106 in response to the future data record recommendation 105, including, e.g., the notification of the prediction, as well as user selectable interface elements to address the prediction of the future data record recommendation 105.

In some embodiments, the notification of the future data record recommendation 105 may include, e.g., attributes identifying the electronic activity of each historical data record, such as, e.g., the entity associated with the electronic activity, the date, the electronic activity execution device 101, among other attributes. Additionally, the notification may include, e.g., an interface element representing the recurring data record pattern or cadence. As a result, the user may respond to the alert of the future data record recommendation 105 to, e.g., proactively dispute the future data record of the future data record recommendation 105, select a link associated with the entity of each historical data record to proactively execute the associated future electronic activity, select a link to add a digital calendar entry scheduling the associated future electronic activity, modify, adjust or correct the future data record recommendation 105 or otherwise take proactive action.

In some embodiments, the computing device 102 may include a software application or program that include functionality to detect the receipt of the future data record recommendation 105 and produce the recommendation interface 106 in response. In some embodiments, the future data record recommendation 105 includes functionality to cause the computing device 102 to display the recommendation interface 106. For example, the notification of the future data record recommendation 105 may include a link that, upon selection, may automatically generate an internet-based request to dispute or decline the future data record recommendation 105. In another example, the computing device 102 may include an application associated with the recommendation sub-system 110 that may generate and display the recommendation interface 106 automatically in response to the future data record recommendation 105.

In some embodiments, the recommendation interface 106 may include user interface elements that provide details of the future data record recommendation 105 to the user. For example, the recommendation interface 106 may identify the future data record associated with the future data record recommendation 105, the entity associated with the future data record, a date of the future data record, a time of the future data record, a location of the future data record, a value or quantity of the future data record, among other suitable information. In some embodiments, accompanying the information may be a user-selectable interface element providing one-click functionality to dispute the recurrence of data records after the recurring period on the grounds of the future data record recommendation 105. Selection of this one-click interface element may produce a feedback 107 and issue the feedback 107 to the recommendation sub-system 110.

In some embodiments, the feedback 107 may include, e.g., a dispute of the future data record to indicate that the future data record was incorrectly entered, a modification to data attributes of the future data record, or other feedback. In some embodiments, the feedback 107 may include, e.g., a user selection of the attribute or attributes of the future data record that are incorrect and/or a user selection of correct attributes of the future data record. In some embodiments, the feedback 107 may include, e.g., a confirmation to confirm the validity of the future data record.

In some embodiments, the computing device 102 may issue the feedback 107 by communicating the feedback 107 to the recommendation sub-system 110. In some embodiments, the feedback 107 may trigger in the recommendation sub-system 110, e.g., by the recurrence detection service 120, a process to correct the data attributes of the data records in the set of recurring data records in the record history 117. Accordingly, the recommendation sub-system 110 may enable users to quickly and efficiently respond to, correct and otherwise act on predicted future data records and associated future electronic activities.

In some embodiments, the pattern recognition model engine 130 may utilize the feedback 107 to update the recurring pattern parameters based on, e.g., the modifications to the data attributes by the user. The pattern recognition model engine 130 may determine a difference between the predicted recurring data record patterns and the modification to the data attributes to determine a loss or error associated with the recurring pattern parameters. The loss or error may be utilized to training, in an online fashion, the machine learning model or models of the pattern recognition model engine 130 to more accurately predict recurring data record patterns.

In some embodiments, the recommendation sub-system 110 may be configured to automatically schedule an electronic activity in response to the future data record recommendation 105. For example, in some embodiments, the recommendation sub-system 110 may be configured to interact with the computing device 102 to trigger the creation of an electronic event object specifying an electronic object event representing the future data record recommendation 105 or an electronic activity associated therewith, or both. In some embodiments, the electronic event object may include a software object or database object for use by, e.g., a schedule system such as a computation resource schedule system or user scheduling system (e.g., electronic or digital calendar) to schedule events including electronic activities. Thus, a software application of the recommendation interface 106 may interact with the schedule system to create the electronic event object automatically.

In some embodiments, the recommendation sub-system 110 may additionally or instead initiate an electronic activity for future execution according to the future data record recommendation 105. For example, in some embodiments, the recommendation sub-system 110 may identify the entity of the entity attribute specified in the recurring data records. Using the entity identifier, the recommendation sub-system 110 may, e.g., reference an application programming interface (API) library 114. In some embodiments, the API library 114 include future data record APIs associated with one or more entities that enable the creation of a scheduling, appointment, booking or other future initiation for the future electronic activity of the future data record. For example, an API request to the future data record API of a particular entity may, e.g., automatically cause an electronic activity to be executed (e.g., via electronic electronic activity execution device 101) at a date and time in the future according to the date attribute and time attribute of the future data record recommendation 105. In some embodiments, the API request may additionally or instead create an event object at a computing device associated with a particular entity in accordance with the future data record recommendation 105. Accordingly, upon identifying the future data record API in the API library 114 for the entity of the future data record recommendation 105, the recommendation sub-system 110 may automatically issue an API request to secure the date and time of the future data record recommendation 105 on the behalf of the user.

In some embodiments, the term “application programming interface” or “API” refers to a computing interface that defines interactions between multiple software intermediaries. An “application programming interface” or “API” defines the kinds of calls or requests that can be made, how to make the calls, the data formats that should be used, the conventions to follow, among other requirements and constraints. An “application programming interface” or “API” can be entirely custom, specific to a component, or designed based on an industry-standard to ensure interoperability to enable modular programming through information hiding, allowing users to use the interface independently of the implementation.

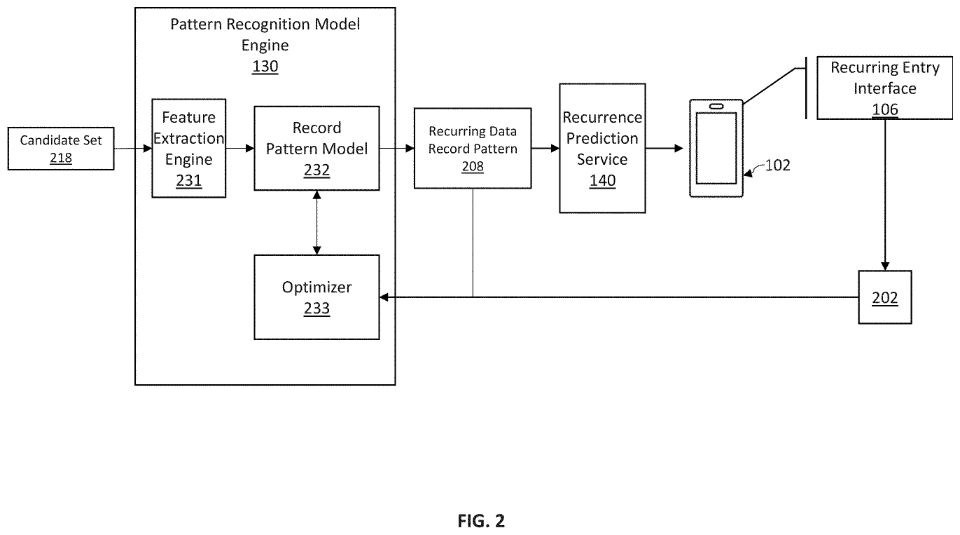

FIG. 2 is a block diagram of another exemplary computer-based system including a recurring entry model engine for the automated detection of recurring data records for predicting recurring data records in accordance with one or more embodiments of the present disclosure.

In some embodiments, the pattern recognition model engine 130 may access, receive or otherwise obtain the candidate set 218 of recurring data records, e.g., from the recurrence detection service 120. A record pattern model 232 of the pattern recognition model engine 130 may generate recurring data record pattern 208 based on data regarding electronic activities from the data records in the candidate set 218.

In some embodiments, to ingest the data of each data record, the pattern recognition model engine 130 may extract attributes and characteristics to formulate features for use in the record pattern model 232 to identify a pattern of recurrence, such as a cadence, according to the electronic activities indicating a recurring electronic activity between the user and the entity.

Accordingly, in some embodiments, a feature extraction engine 231 of the pattern recognition model engine 130 may extract data attributes such as, e.g., a user identifier associated with each data record, an entity identifier associated with each data record, an activity type identifier, an activity value or activity quantity attribute, a time attribute, a location attribute, a date attribute, a device type or device identifier associated with the electronic activity execution device 101, an activity description, or other attributes representing characteristics of each data record. For example, in some embodiments, the feature extraction engine 231 may examine metadata associated with each data record in the candidate set 218 to identify, e.g., location attribute, date attribute, time attribute, entity or device identifiers, entity and/or device type, a value or quantity attribute, an activity operation and/or operation type, an activity type or category attribute, associated data fraud or security checks among other attributes and characteristics associated with the electronic activity. However, in some embodiments, one or more of the attributes and characteristics may be explicitly specified in the candidate set 218. In some embodiments, the candidate set 218 may also specify, e.g., the user identifier, entity identifier, the activity value or activity quantity, the activity type, the activity operation, among other data attributes and characteristics and combinations thereof.

In some embodiments, the feature extraction engine 231 may generate features based on the data items extracted from the data records. For example, the features may include, e.g., average activity frequency, average activity volume (e.g., account to activity quantity or activity value), seasonal changes to average activity frequency or volume, average activity frequency per activity category, average activity volume (e.g., account to activity quantity or activity value) per activity category, seasonal changes to average activity frequency or volume per activity category, among other features. In some embodiments, the feature extraction engine 231 may encode the features extracted from data records into a feature vector. In some embodiments, the feature vector may include a one-dimensional vector of values representing each extracted feature. Accordingly, the feature vector may be efficiently ingested by a machine learning model for prediction.

In some embodiments, the pattern recognition model engine 130 may utilize the record pattern model 232 to predict a recurring data record pattern 208 for the feature vector associated with the candidate set 218.

In some embodiments, the record pattern model 232 ingests the feature vector and produces a prediction of a recurring data record pattern 208 for each feature vector. In some embodiments, to produce this prediction, the record pattern model 232 may include a machine learning model including a regression model to predict a value indicative of a predicted pattern of electronic activities, such as, e.g., a recurrent neural network (RNN), convolutional neural network (CNN), an autoencoder, a Naive Bayes classifier, decision trees, random forest, support vector machine (SVM), K-Nearest Neighbors, or any other suitable algorithm for a regression model.

Accordingly, the record pattern model 232 ingests the feature vector and processes the attributes encoded therein using the regression model to produce a model output vector. In some embodiments, the model output vector may be decoded to generate the value indicative of the predicted pattern including the recurring data record pattern 208. In some embodiments, the model output vector may include or may be decoded to reveal a numerical output, e.g., a particular cadence in days, weeks, months, years, etc.

In some embodiments, the model output vector or an additional model output vector may also include, e.g., a probability value may indicate a degree of probability that the candidate set 218 of recurring data records of the feature vector is in fact a set of recurring data records associated with a recurring electronic activity. In some embodiments, the record pattern model 232 may test the probability value against a probability threshold, where a probability value greater than the probability threshold indicates, e.g., that the candidate set 218 includes recurring data record, or that the candidate set 218 does not include recurring data records. For example, the probability threshold can be, e.g., greater than 0.5, greater than 0.6, greater than 0.7, greater than 0.8, greater than 0.9, or other suitable threshold value. In some embodiments, the record pattern model 232 may determine whether the candidate set 218 includes recurring data records based on the probability value and the probability threshold. For example, the recurring data record pattern 208 may specify that the candidate set 218 includes recurring data records where the probability value is greater than the probability threshold. However, the record pattern model 232 may be configured such that the recurring data record pattern 208 may specify that the candidate set 218 does not include recurring data records where the probability value is greater than the probability threshold.

Moreover, in some embodiments, the model output vector may include or may be decoded to reveal attributes of the recurring data record pattern of recurring data records. For example, the model output vector may include, e.g., a prediction for a recurring period or cadence, recurring period duration, recurring period end data, sequence start date, sequence recurrence period, recurring data record quantity attribute, among other attributes of the sequence of recurring data records.

In some embodiments, as described above, the recurrence prediction service 140 may use the recurring data record pattern 208 prediction to determine a future data record and attributes thereof. In some embodiments, the data attributes of the future data record may trigger the computing device 102 to generate and display the recommendation interface 106. In some embodiments, the recommendation interface 106 includes a depiction or representation of, e.g., the data attributes, the future data records, the future electronic activity, a scheduling for the future data record and/or future electronic activity, or a combination thereof, as well as an interface element to confirm, deny or modify the recurring data record pattern 208, such as modifications to data attributes of the future data record. For example, the user may input a user interaction 202 with an option to confirm the recurring data record pattern 208 as correct or deny the recurring data record pattern 208 as incorrect or adjust attributes to correct the recurring data record pattern 208. In some embodiments, the user interaction 202 may include a user selection of a confirm option or a deny option relative to the recurring data record pattern 208.

In some embodiments, the user interaction 202 may also include a lack of a selection. For example, the user may choose to ignore the notification of the recommendation interface 106, e.g., by selecting an “ignore” element, or by not providing any selection at all. In some embodiments, where the user ignores the recommendation interface 106, the lack of selection may be interpreted as a confirmation of the future data record according to the recurring data record pattern 208. In another embodiments, the lack of selection may be interpreted as a denial of the future data record according to the recurring data record pattern 208. Accordingly, the user interaction 202 may include an indication of a confirmation or denial of the recurring data record pattern 208 based on the user's lack of interaction.

In some embodiments, in the case of the lack of any selection, the user interaction 202 may be determined to be an ignore interaction after a predetermined period of time has elapsed without any user selection. For example, the optimizer 233 may include a timer that starts upon generation of the recurring data record pattern 208 and ends upon the predetermined time period elapsing. Alternatively, or in addition, the computing device 102 and/or recommendation interface 106 may include the timer that starts upon receiving the recurring data record pattern 208. In some embodiments, the predetermined period of time may include any suitable time period for user interaction with the recommendation interface 106, such as, e.g., 15 seconds, 30 seconds, 40 seconds, 40 seconds, 45 seconds, 1 minute, 3 minutes, 5 minutes, or any other suitable time period.

In some embodiments, the record pattern model 232 may be trained based on the recurring data record pattern 208 and the user interaction 202. Based on the difference between the recurring data record pattern 208 and the user interaction 202, the parameters of the record pattern model 232 may be updated to improve the accuracy of the future data record recommendation 105.

In some embodiments, training is performed using the optimizer 233. In some embodiments, the recurring data record pattern 208 is fed back to the optimizer 233. The optimizer 233 may also ingest the user interaction 202, such as feedback 107 described above. In some embodiments, the optimizer 233 may employ a loss function, such as, e.g., Hinge Loss, Multi-class SVM Loss, Cross Entropy Loss, Negative Log Likelihood, or other suitable classification loss function. The loss function determines an error based on the user interaction 202 and the recurring data record pattern 208. In some embodiments, the optimizer 233 may, e.g., backpropagate the error to the record pattern model 232 to update the parameters using, e.g., gradient descent, heuristic, convergence or other optimization techniques and combinations thereof.

In some embodiments, the optimizer 233 may therefore train the parameters of the record pattern model 232 to approximate user behaviors in initiating a recurring electronic activity to produce recurring data records based on feedback including the user interaction 202. As a result, the record pattern model 232 may be continually trained and optimized based on user feedback. In some embodiments, the record pattern model 232 may also or instead be pretrained using a similar process with a training dataset. In some embodiments, the training dataset may include known recurring data records annotated with known cadences. The optimizer 233 may train the parameters of the record pattern model 232 according to a difference between a predicted recurring data record pattern 208 for each recurring data record set and the annotated cadence. In some embodiments, the pattern recognition model engine 130 may utilize both pretraining and continual training.

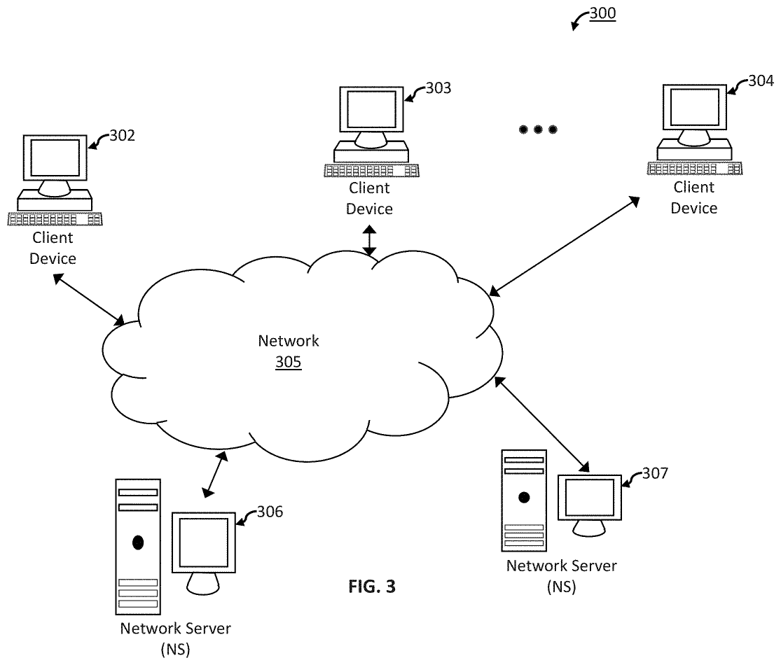

FIG. 3 depicts a block diagram of an exemplary computer-based system and platform 300 in accordance with one or more embodiments of the present disclosure. However, not all of these components may be required to practice one or more embodiments, and variations in the arrangement and type of the components may be made without departing from the spirit or scope of various embodiments of the present disclosure. In some embodiments, the illustrative computing devices and the illustrative computing components of the exemplary computer-based system and platform 300 may be configured to manage a large number of members and concurrent transactions, as detailed herein. In some embodiments, the exemplary computer-based system and platform 300 may be based on a scalable computer and network architecture that incorporates varies strategies for assessing the data, caching, searching, and/or database connection pooling. An example of the scalable architecture is an architecture that is capable of operating multiple servers.

In some embodiments, referring to FIG. 3, member computing device 302, member computing device 303 through member computing device 304 (e.g., clients) of the exemplary computer-based system and platform 300 may include virtually any computing device capable of receiving and sending a message over a network (e.g., cloud network), such as network 305, to and from another computing device, such as servers 306 and 307, each other, and the like. In some embodiments, the member devices 302-304 may be personal computers, multiprocessor systems, microprocessor-based or programmable consumer electronics, network PCs, and the like. In some embodiments, one or more member devices within member devices 302-304 may include computing devices that typically connect using a wireless communications medium such as cell phones, smart phones, pagers, walkie talkies, radio frequency (RF) devices, infrared (IR) devices, CBs, integrated devices combining one or more of the preceding devices, or virtually any mobile computing device, and the like. In some embodiments, one or more member devices within member devices 302-304 may be devices that are capable of connecting using a wired or wireless communication medium such as a PDA, POCKET PC, wearable computer, a laptop, tablet, desktop computer, a netbook, a video game device, a pager, a smart phone, an ultra-mobile personal computer (UMPC), and/or any other device that is equipped to communicate over a wired and/or wireless communication medium (e.g., NFC, RFID, NBIOT, 3G, 4G, 5G, GSM, GPRS, WiFi, WiMax, CDMA, satellite, ZigBee, etc.). In some embodiments, one or more member devices within member devices 302-304 may include may run one or more applications, such as Internet browsers, mobile applications, voice calls, video games, videoconferencing, and email, among others. In some embodiments, one or more member devices within member devices 302-304 may be configured to receive and to send web pages, and the like. In some embodiments, an exemplary specifically programmed browser application of the present disclosure may be configured to receive and display graphics, text, multimedia, and the like, employing virtually any web based language, including, but not limited to Standard Generalized Markup Language (SMGL), such as HyperText Markup Language (HTML), a wireless application protocol (WAP), a Handheld Device Markup Language (HDML), such as Wireless Markup Language (WML), WMLScript, XML, JavaScript, and the like. In some embodiments, a member device within member devices 302-304 may be specifically programmed by either Java, .Net, QT, C, C++ and/or other suitable programming language. In some embodiments, one or more member devices within member devices 302-304 may be specifically programmed include or execute an application to perform a variety of possible tasks, such as, without limitation, messaging functionality, browsing, searching, playing, streaming or displaying various forms of content, including locally stored or uploaded messages, images and/or video, and/or games.

In some embodiments, the exemplary network 305 may provide network access, data transport and/or other services to any computing device coupled to it. In some embodiments, the exemplary network 305 may include and implement at least one specialized network architecture that may be based at least in part on one or more standards set by, for example, without limitation, Global System for Mobile communication (GSM) Association, the Internet Engineering Task Force (IETF), and the Worldwide Interoperability for Microwave Access (WiMAX) forum. In some embodiments, the exemplary network 305 may implement one or more of a GSM architecture, a General Packet Radio Service (GPRS) architecture, a Universal Mobile Telecommunications System (UMTS) architecture, and an evolution of UMTS referred to as Long Term Evolution (LTE). In some embodiments, the exemplary network 305 may include and implement, as an alternative or in conjunction with one or more of the above, a WiMAX architecture defined by the WiMAX forum. In some embodiments and, optionally, in combination of any embodiment described above or below, the exemplary network 305 may also include, for instance, at least one of a local area network (LAN), a wide area network (WAN), the Internet, a virtual LAN (VLAN), an enterprise LAN, a layer 3 virtual private network (VPN), an enterprise IP network, or any combination thereof. In some embodiments and, optionally, in combination of any embodiment described above or below, at least one computer network communication over the exemplary network 305 may be transmitted based at least in part on one of more communication modes such as but not limited to: NFC, RFID, Narrow Band Internet of Things (NBIOT), ZigBee, 3G, 4G, 5G, GSM, GPRS, WiFi, WiMax, CDMA, satellite and any combination thereof. In some embodiments, the exemplary network 305 may also include mass storage, such as network attached storage (NAS), a storage area network (SAN), a content delivery network (CDN) or other forms of computer or machine readable media.

In some embodiments, the exemplary server 306 or the exemplary server 307 may be a web server (or a series of servers) running a network operating system, examples of which may include but are not limited to Microsoft Windows Server, Novell NetWare, or Linux. In some embodiments, the exemplary server 306 or the exemplary server 307 may be used for and/or provide cloud and/or network computing. Although not shown in FIG. 3, in some embodiments, the exemplary server 306 or the exemplary server 307 may have connections to external systems like email, SMS messaging, text messaging, ad content providers, etc. Any of the features of the exemplary server 306 may be also implemented in the exemplary server 307 and vice versa.

In some embodiments, one or more of the exemplary servers 306 and 307 may be specifically programmed to perform, in non-limiting example, as authentication servers, search servers, email servers, social networking services servers, SMS servers, IM servers, MMS servers, exchange servers, photo-sharing services servers, advertisement providing servers, financial/banking-related services servers, travel services servers, or any similarly suitable service-base servers for users of the member computing devices 301-304.

In some embodiments and, optionally, in combination of any embodiment described above or below, for example, one or more exemplary computing member devices 302-304, the exemplary server 306, and/or the exemplary server 307 may include a specifically programmed software module that may be configured to send, process, and receive information using a scripting language, a remote procedure call, an email, a tweet, Short Message Service (SMS), Multimedia Message Service (MMS), instant messaging (IM), internet relay chat (IRC), mIRC, Jabber, an application programming interface, Simple Object Access Protocol (SOAP) methods, Common Object Request Broker Architecture (CORBA), HTTP (Hypertext Transfer Protocol), REST (Representational State Transfer), or any combination thereof.

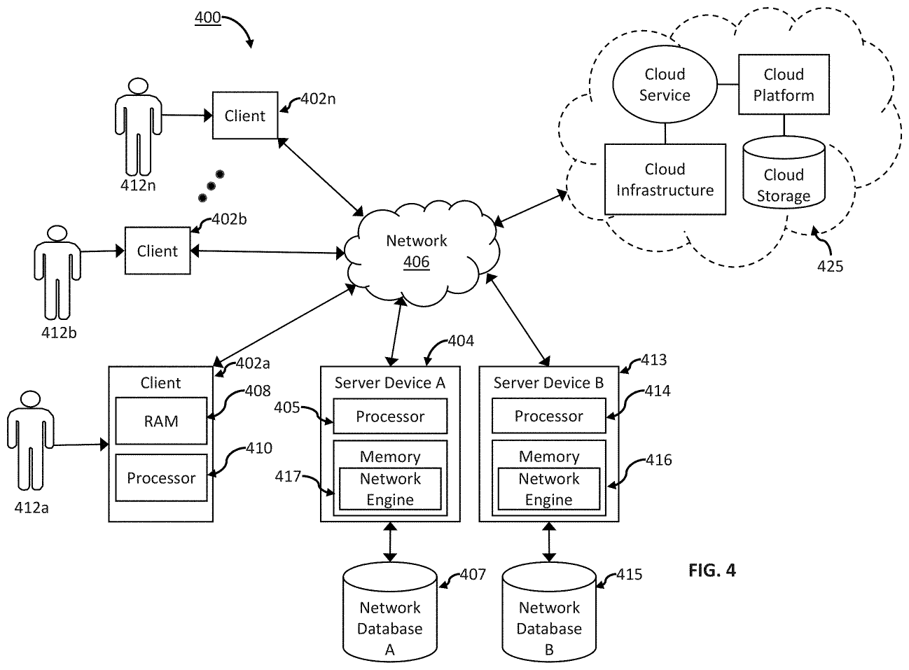

FIG. 4 depicts a block diagram of another exemplary computer-based system and platform 400 in accordance with one or more embodiments of the present disclosure. However, not all of these components may be required to practice one or more embodiments, and variations in the arrangement and type of the components may be made without departing from the spirit or scope of various embodiments of the present disclosure. In some embodiments, the member computing device 402a, member computing device 402b through member computing device 402n shown each at least includes a computer-readable medium, such as a random-access memory (RAM) 408 coupled to a processor 410 or FLASH memory. In some embodiments, the processor 410 may execute computer-executable program instructions stored in memory 408. In some embodiments, the processor 410 may include a microprocessor, an ASIC, and/or a state machine. In some embodiments, the processor 410 may include, or may be in communication with, media, for example computer-readable media, which stores instructions that, when executed by the processor 410, may cause the processor 410 to perform one or more steps described herein. In some embodiments, examples of computer-readable media may include, but are not limited to, an electronic, optical, magnetic, or other storage or transmission device capable of providing a processor, such as the processor 410 of member computing device 402a, with computer-readable instructions. In some embodiments, other examples of suitable media may include, but are not limited to, a floppy disk, CD-ROM, DVD, magnetic disk, memory chip, ROM, RAM, an ASIC, a configured processor, all optical media, all magnetic tape or other magnetic media, or any other medium from which a computer processor can read instructions. Also, various other forms of computer-readable media may transmit or carry instructions to a computer, including a router, private or public network, or other transmission device or channel, both wired and wireless. In some embodiments, the instructions may comprise code from any computer-programming language, including, for example, C, C++, Visual Basic, Java, Python, Perl, JavaScript, and etc.

In some embodiments, member computing devices 402a through 402n may also comprise a number of external or internal devices such as a mouse, a CD-ROM, DVD, a physical or virtual keyboard, a display, or other input or output devices. In some embodiments, examples of member computing devices 402a through 402n (e.g., clients) may be any type of processor-based platforms that are connected to a network 406 such as, without limitation, personal computers, digital assistants, personal digital assistants, smart phones, pagers, digital tablets, laptop computers, Internet appliances, and other processor-based devices. In some embodiments, member computing devices 402a through 402n may be specifically programmed with one or more application programs in accordance with one or more principles/methodologies detailed herein. In some embodiments, member computing devices 402a through 402n may operate on any operating system capable of supporting a browser or browser-enabled application, such as Microsoft™, Windows™, and/or Linux. In some embodiments, member computing devices 402a through 402n shown may include, for example, personal computers executing a browser application program such as Microsoft Corporation's Internet Explorer™, Apple Computer, Inc.'s Safari™, Mozilla Firefox, and/or Opera. In some embodiments, through the member computing client devices 402a through 402n, user 412a, user 412b through user 412n, may communicate over the exemplary network 406 with each other and/or with other systems and/or devices coupled to the network 406. As shown in FIG. 4, exemplary server devices 404 and 413 may include processor 405 and processor 414, respectively, as well as memory 417 and memory 416, respectively. In some embodiments, the server devices 404 and 413 may be also coupled to the network 406. In some embodiments, one or more member computing devices 402a through 402n may be mobile clients.

In some embodiments, at least one database of exemplary databases 407 and 415 may be any type of database, including a database managed by a database management system (DBMS). In some embodiments, an exemplary DBMS-managed database may be specifically programmed as an engine that controls organization, storage, management, and/or retrieval of data in the respective database. In some embodiments, the exemplary DBMS-managed database may be specifically programmed to provide the ability to query, backup and replicate, enforce rules, provide security, compute, perform change and access logging, and/or automate optimization. In some embodiments, the exemplary DBMS-managed database may be chosen from Oracle database, IBM DB2, Adaptive Server Enterprise, FileMaker, Microsoft Access, Microsoft SQL Server, MySQL, PostgreSQL, and a NoSQL implementation. In some embodiments, the exemplary DBMS-managed database may be specifically programmed to define each respective schema of each database in the exemplary DBMS, according to a particular database model of the present disclosure which may include a hierarchical model, network model, relational model, object model, or some other suitable organization that may result in one or more applicable data structures that may include fields, records, files, and/or objects. In some embodiments, the exemplary DBMS-managed database may be specifically programmed to include metadata about the data that is stored.

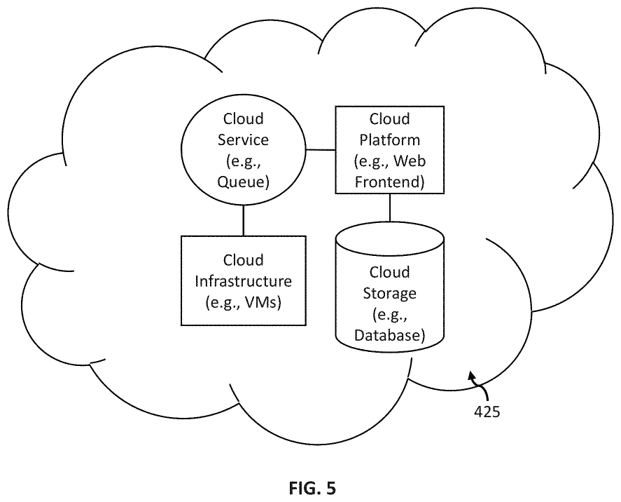

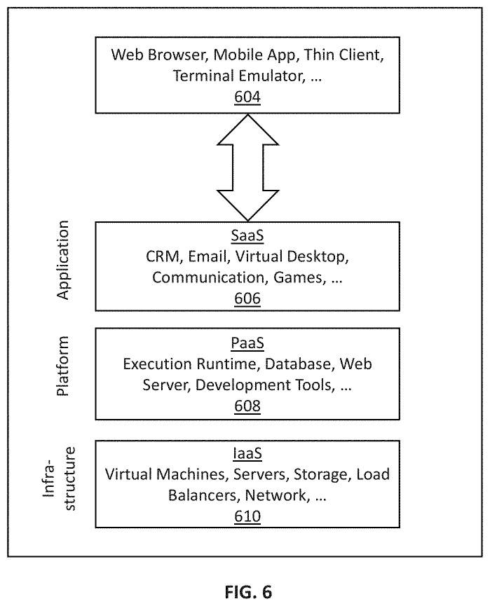

In some embodiments, the exemplary inventive computer-based systems/platforms, the exemplary inventive computer-based devices, and/or the exemplary inventive computer-based components of the present disclosure may be specifically configured to operate in a cloud computing/architecture 425 such as, but not limiting to: infrastructure a service (IaaS) 610, platform as a service (PaaS) 608, and/or software as a service (SaaS) 606 using a web browser, mobile app, thin client, terminal emulator or other endpoint 604. FIGS. 5 and 6 illustrate schematics of exemplary implementations of the cloud computing/architecture(s) in which the exemplary inventive computer-based systems/platforms, the exemplary inventive computer-based devices, and/or the exemplary inventive computer-based components of the present disclosure may be specifically configured to operate.

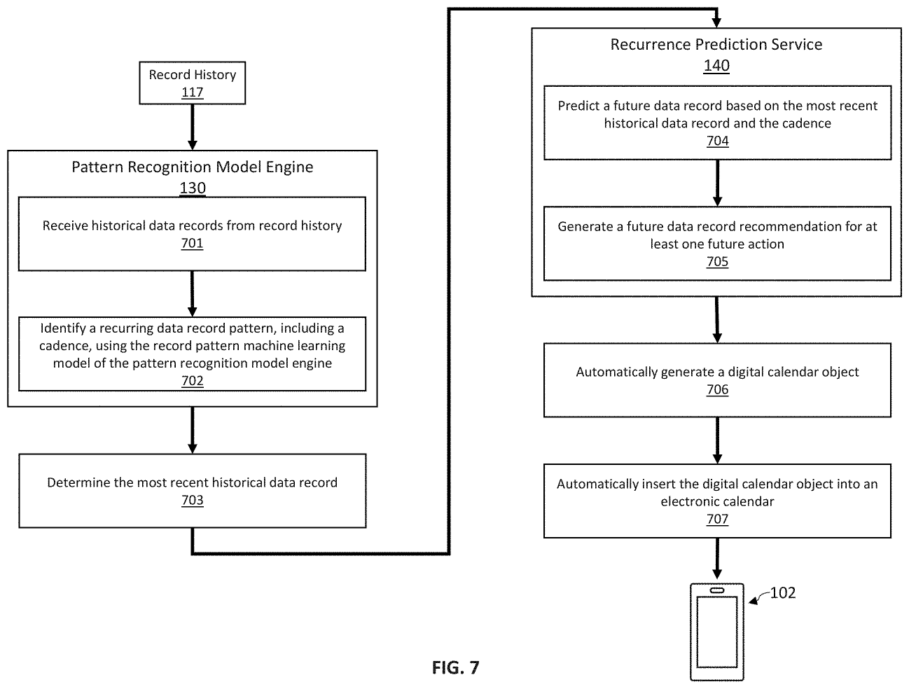

FIG. 7 illustrates a flowchart of a method for the automated detection of recurring data records for predicting recurring and future data records according to illustrative embodiments of the present disclosure.

In some embodiments, the record history 117 may be used to automatically insert digital calendar objects into a user's electronic calendar associated with, e.g., the computing device 102. To do so, a pattern recognition model engine 130 may be utilized. At least one processor associated with the pattern recognition model engine 130 may receive historical data records from the record history 117 at block 701. In some embodiments, each historical data record may include, e.g., a quantity attribute indicative of a quantity, a date attribute indicative of a date, and an entity attribute indicative of a corresponding entity, among other attributes.

The pattern recognition model engine 130 may be utilized at block 702 to identify, with a record pattern machine learning model, a recurring data record pattern. In some embodiments, the record pattern matching learning model may include trained record pattern parameters that have been trained against known recurring data record patterns for a particular entity in a whitelist of entities for which recurring data records are applicable. In some embodiments, the recurring data record pattern may include a set of recurring data records that repeat with sporadic intervals, and a cadence of recurrence of the quantity and entity attributes of each historical data record in the set of recurring data records. In some embodiments, the cadence of recurrence may be identified as a regular interval that is representative of sporadic intervals.

In some embodiments, the at least one processor may determine at block 703, the most recent historical data record in the set of recurring data records based on the date attribute of each historical data record. The at least one processor may utilize a recurrence prediction service 140 to predict a future data record and generate recommendations for the future data record.

In some embodiments, the recurrence prediction service 140 may predict, at block 704, a future data record based on the most recent historical data record and the recurring data record pattern, including the cadence. For example, the recurrence prediction service 140 may predict a future date attribute based on the cadence and the date attribute of the most recent historical data record (e.g., by adding the cadence to the date attribute). Additionally, the recurrence prediction service 140 may predict future data attributes to include the recurring data attributes of the historical data records in the set of recurring data records, such as, e.g., the entity attribute, the quantity attribute, among others.

In some embodiments, the recurrence prediction service 140 may then generate, at block 705, a future data record recommendation for at least one future action having an action quantity and action entity that matches the quantity attribute and of the entity attribute of each historical data record in the set of recurring data records. In some embodiments, the future data record recommendation may include the future date attribute and the associated future data record date, among other attributes.

In some embodiments, in response to the future data record recommendation, the at least one processor may automatically generate, at block 706, a digital calendar object associated with the entity, where the digital calendar object specifies the future data record recommendation. The at least one processor may then automatically insert, at block 707, the digital calendar object into an electronic calendar associated with the user. In some embodiments, the electronic calendar may be locally stored in the computing device 102, or may be provided to the computing device 102 using, e.g., a cloud service for digital calendaring, or by a hybrid implementation thereof.

It is understood that at least one aspect/functionality of various embodiments described herein can be performed in real-time and/or dynamically. As used herein, the term “real-time” is directed to an event/action that can occur instantaneously or almost instantaneously in time when another event/action has occurred. For example, the “real-time processing,” “real-time computation,” and “real-time execution” all pertain to the performance of a computation during the actual time that the related physical process (e.g., a user interacting with an application on a mobile device) occurs, in order that results of the computation can be used in guiding the physical process.

As used herein, the term “dynamically” and term “automatically,” and their logical and/or linguistic relatives and/or derivatives, mean that certain events and/or actions can be triggered and/or occur without any human intervention. In some embodiments, events and/or actions in accordance with the present disclosure can be in real-time and/or based on a predetermined periodicity of at least one of: nanosecond, several nanoseconds, millisecond, several milliseconds, second, several seconds, minute, several minutes, hourly, several hours, daily, several days, weekly, monthly, etc.

As used herein, the term “runtime” corresponds to any behavior that is dynamically determined during an execution of a software application or at least a portion of software application.

In some embodiments, exemplary inventive, specially programmed computing systems and platforms with associated devices are configured to operate in the distributed network environment, communicating with one another over one or more suitable data communication networks (e.g., the Internet, satellite, etc.) and utilizing one or more suitable data communication protocols/modes such as, without limitation, IPX/SPX, X.25, AX.25, AppleTalk(™), TCP/IP (e.g., HTTP), near-field wireless communication (NFC), RFID, Narrow Band Internet of Things (NBIOT), 3G, 4G, 5G, GSM, GPRS, WiFi, WiMax, CDMA, satellite, ZigBee, and other suitable communication modes. In some embodiments, the NFC can represent a short-range wireless communications technology in which NFC-enabled devices are “swiped,” “bumped,” “tap” or otherwise moved in close proximity to communicate. In some embodiments, the NFC could include a set of short-range wireless technologies, typically requiring a distance of 10 cm or less. In some embodiments, the NFC may operate at 13.56 MHz on ISO/IEC 18000-3 air interface and at rates ranging from 106 kbit/s to 424 kbit/s. In some embodiments, the NFC can involve an initiator and a target; the initiator actively generates an RF field that can power a passive target. In some embodiments, this can enable NFC targets to take very simple form factors such as tags, stickers, key fobs, or cards that do not require batteries. In some embodiments, the NFC's peer-to-peer communication can be conducted when a plurality of NFC-enable devices (e.g., smartphones) within close proximity of each other.

The material disclosed herein may be implemented in software or firmware or a combination of them or as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, etc.).

In some embodiments, one or more of illustrative computer-based systems or platforms of the present disclosure may include or be incorporated, partially or entirely into at least one personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

As used herein, the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

In some embodiments, as detailed herein, one or more of the computer-based systems of the present disclosure may obtain, manipulate, transfer, store, transform, generate, and/or output any digital object and/or data unit (e.g., from inside and/or outside of a particular application) that can be in any suitable form such as, without limitation, a file, a contact, a task, an email, a message, a map, an entire application (e.g., a calculator), data points, and other suitable data. In some embodiments, as detailed herein, one or more of the computer-based systems of the present disclosure may be implemented across one or more of various computer platforms such as, but not limited to: (1) Linux, (2) Microsoft Windows, (3) OS X (Mac OS), (4) Solaris, (5) UNIX (6) VMWare, (7) Android, (8) Java Platforms, (9) Open Web Platform, (10) Kubernetes or other suitable computer platforms. In some embodiments, illustrative computer-based systems or platforms of the present disclosure may be configured to utilize hardwired circuitry that may be used in place of or in combination with software instructions to implement features consistent with principles of the disclosure. Thus, implementations consistent with principles of the disclosure are not limited to any specific combination of hardware circuitry and software. For example, various embodiments may be embodied in many different ways as a software component such as, without limitation, a stand-alone software package, a combination of software packages, or it may be a software package incorporated as a “tool” in a larger software product.

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device.

In some embodiments, illustrative computer-based systems or platforms of the present disclosure may be configured to handle numerous concurrent users that may be, but is not limited to, at least 100 (e.g., but not limited to, 100-999), at least 1,000 (e.g., but not limited to, 1,000-9,999), at least 10,000 (e.g., but not limited to, 10,000-99,999), at least 100,000 (e.g., but not limited to, 100,000-999,999), at least 1,000,000 (e.g., but not limited to, 1,000,000-9,999,999), at least 10,000,000 (e.g., but not limited to, 10,000,000-99,999,999), at least 100,000,000 (e.g., but not limited to, 100,000,000-999,999,999), at least 1,000,000,000 (e.g., but not limited to, 1,000,000,000-999,999,999,999), and so on.

In some embodiments, illustrative computer-based systems or platforms of the present disclosure may be configured to output to distinct, specifically programmed graphical user interface implementations of the present disclosure (e.g., a desktop, a web app., etc.). In various implementations of the present disclosure, a final output may be displayed on a displaying screen which may be, without limitation, a screen of a computer, a screen of a mobile device, or the like. In various implementations, the display may be a holographic display. In various implementations, the display may be a transparent surface that may receive a visual projection. Such projections may convey various forms of information, images, or objects. For example, such projections may be a visual overlay for a mobile augmented reality (MAR) application.

In some embodiments, illustrative computer-based systems or platforms of the present disclosure may be configured to be utilized in various applications which may include, but not limited to, gaming, mobile-device games, video chats, video conferences, live video streaming, video streaming and/or augmented reality applications, mobile-device messenger applications, and others similarly suitable computer-device applications.

As used herein, the term “mobile electronic device,” or the like, may refer to any portable electronic device that may or may not be enabled with location tracking functionality (e.g., MAC address, Internet Protocol (IP) address, or the like). For example, a mobile electronic device can include, but is not limited to, a mobile phone, Personal Digital Assistant (PDA), Blackberry™, Pager, Smartphone, or any other reasonable mobile electronic device.

As used herein, the terms “proximity detection,” “locating,” “location data,” “location information,” and “location tracking” refer to any form of location tracking technology or locating method that can be used to provide a location of, for example, a particular computing device, system or platform of the present disclosure and any associated computing devices, based at least in part on one or more of the following techniques and devices, without limitation: accelerometer(s), gyroscope(s), Global Positioning Systems (GPS); GPS accessed using Bluetooth™; GPS accessed using any reasonable form of wireless and non-wireless communication; WiFi™ server location data; Bluetooth™ based location data; triangulation such as, but not limited to, network based triangulation, WiFi™ server information based triangulation, Bluetooth™ server information based triangulation; Cell Identification based triangulation, Enhanced Cell Identification based triangulation, Uplink-Time difference of arrival (U-TDOA) based triangulation, Time of arrival (TOA) based triangulation, Angle of arrival (AOA) based triangulation; techniques and systems using a geographic coordinate system such as, but not limited to, longitudinal and latitudinal based, geodesic height based, Cartesian coordinates based; Radio Frequency Identification such as, but not limited to, Long range RFID, Short range RFID; using any form of RFID tag such as, but not limited to active RFID tags, passive RFID tags, battery assisted passive RFID tags; or any other reasonable way to determine location. For ease, at times the above variations are not listed or are only partially listed; this is in no way meant to be a limitation.

As used herein, the terms “cloud,” “Internet cloud,” “cloud computing,” “cloud architecture,” and similar terms correspond to at least one of the following: (1) a large number of computers connected through a real-time communication network (e.g., Internet); (2) providing the ability to run a program or application on many connected computers (e.g., physical machines, virtual machines (VMs)) at the same time; (3) network-based services, which appear to be provided by real server hardware, and are in fact served up by virtual hardware (e.g., virtual servers), simulated by software running on one or more real machines (e.g., allowing to be moved around and scaled up (or down) on the fly without affecting the end user).

In some embodiments, the illustrative computer-based systems or platforms of the present disclosure may be configured to securely store and/or transmit data by utilizing one or more of encryption techniques (e.g., private/public key pair, Triple Data Encryption Standard (3DES), block cipher algorithms (e.g., IDEA, RC2, RC5, CAST and Skipjack), cryptographic hash algorithms (e.g., MD5, RIPEMD-160, RTR0, SHA-1, SHA-2, Tiger (TTH), WHIRLPOOL, RNGs).

As used herein, the term “user” shall have a meaning of at least one user. In some embodiments, the terms “user”, “subscriber” “consumer” or “customer” should be understood to refer to a user of an application or applications as described herein and/or a consumer of data supplied by a data provider. By way of example, and not limitation, the terms “user” or “subscriber” can refer to a person who receives data provided by the data or service provider over the Internet in a browser session, or can refer to an automated software application which receives the data and stores or processes the data.

The aforementioned examples are, of course, illustrative and not restrictive.

At least some aspects of the present disclosure will now be described with reference to the following numbered clauses.
1. A method comprising:

receiving, by at least one processor, data record history comprising a plurality of historical data records associated with a user;
wherein each historical data record of the plurality of historical data records comprises a plurality of data attributes, comprising:
   a quantity attribute indicative of a quantity,
   a date attribute indicative of a date, and
   an entity attribute indicative of a corresponding entity;

utilizing, by the at least one processor, a record pattern machine learning model engine, comprising a record pattern machine learning model of a plurality of trained record pattern parameters, to identify a recurring data record pattern for a particular entity in a whitelist of entities based on the plurality of trained record pattern parameters and the plurality of data attributes of the plurality of historical data records;
wherein the entity attribute matching the particular entity in the whitelist of entities;
wherein the recurring data record pattern comprises a set of recurring data records that repeat with sporadic intervals;
wherein the recurring data record pattern comprises a cadence of recurrence of the quantity attribute and of the entity attribute of each historical data record in the set of recurring data records based on the data attribute of each historical data record in the set of recurring data records;
wherein the cadence of recurrence predicts a regular interval based on the sporadic intervals;

determining, by the at least one processor, the most recent historical data record in the set of recurring data records based on the date attribute of each historical data record in the set of recurring data records;

utilizing, by the at least one processor, a recurrence prediction service, to predict of a future data record in the set of recurring data records based at least in part on the cadence of recurrence and the most recent historical data record, the future data record having a future date attribute;

generating, by the at least one processor, a future data record recommendation for at least one future action having an action quantity and action entity that matches the quantity attribute and of the entity attribute of each historical data record in the set of recurring data records;
wherein the future data record recommendation comprises a future data record date associated with the future date attribute;

automatically generating, by the at least one processor, a digital calendar object associated with the entity, wherein the digital calendar object specifies the future data record recommendation; and

automatically inserting, by the at least one processor, the digital calendar object into an electronic calendar associated with the user.
2. A system comprising:

at least one processor in communication with a non-transitory memory having software instructions stored thereon, wherein the at least one processor is configured, upon execution of the software instructions, to perform steps to:
receive a data record history comprising a plurality of historical data records associated with a user;
   wherein each historical data record of the plurality of historical data records comprises a plurality of data attributes, comprising:
      a quantity attribute indicative of a quantity,
      a date attribute indicative of a date, and
      an entity attribute indicative of an entity;
utilize a record pattern machine learning model engine, comprising a record pattern machine learning model of a plurality of trained record pattern parameters, to identify a recurring data record pattern for a particular entity in a whitelist of entities based on a plurality of the trained record pattern parameters and the plurality of data attributes of the plurality of historical data records;
   wherein the entity attribute matching the particular entity in the whitelist of entities;
   wherein the recurring data record pattern comprises a set of recurring data records that repeat with sporadic intervals;
   wherein the recurring data record pattern comprises a cadence of recurrence of the quantity attribute and of the entity attribute of each historical data record in the set of recurring data records based on the data attribute of each historical data record in the set of recurring data records;
   wherein the cadence of recurrence predicts a regular interval based on the sporadic intervals;
determine the most recent historical data record in the set of recurring data records based on the date attribute of each historical data record in the set of recurring data records;
utilizing a recurrence prediction service to predict a future data record in the set of recurring data records based at least in part on the cadence of recurrence and the most recent historical data record, the future data record having a future date attribute;
generate a future data record recommendation for at least one future action having an action quantity and action entity that matches the quantity attribute and of the entity attribute of each historical data record in the set of recurring data records;
   wherein the future data record recommendation comprises a future data record date associated with the future date attribute;
automatically generate an electronic event object associated with the entity, wherein the electronic event object specifies a future data record for the user according to the future data record recommendation; and
automatically inserting, by the at least one processor, the electronic event object into an electronic calendar associated with the user.
3. The methods and systems of any of clauses 1 through 2, wherein the plurality of data attributes further comprise a time of day attribute indicative of a time of day;

wherein the recurring data record pattern further comprises a time of day pattern based on the time of day attribute of each historical data record in the set of recurring data records.
4. The methods and systems of clause 3, further comprising:

determining, by the at least one processor, an activity associated with each historical data record in the set of recurring data records;

determining, by the at least one processor, an activity length based on the activity; and

determining, by the at least one processor, a scheduled time estimate associated with the set of recurring data records based on the activity length and the time of day pattern.
5. The methods and systems of clause 4, further comprising determining, by the at least one processor, an future data record time for the future data record recommendation based on the scheduled time estimate.
6. The methods and systems of any of clauses 1 through 2, further comprising:

determining, by the at least one processor, a contact method associated with the entity of the entity attribute of each historical data record in the set of recurring data records; and

automatically generating, by the at least one processor, a future data record request via the contact method based on the future data record recommendation.
7. The methods and systems of clause 6, wherein the contact method comprises at least one of:

i) a text message,

ii) a telephone call,

iii) an email, or

iv) a combination thereof.
8. The methods and systems of any of clauses 1 through 2, further comprising:

determining, by the at least one processor, a future data record application programming interface (API) associated with the entity of the entity attribute of each historical data record in the set of recurring data records;
wherein the future data record API enables an automated electronic future data record entry with the entity; and

automatically generating, by the at least one processor, a future data record API request via the future data record API based on the future data record recommendation.
9. The methods and systems of any of clauses 1 through 2, wherein the plurality of historical data records comprise a history of payment authorizations.
10. The methods and systems of any of clauses 1 through 2, wherein the set of recurring data records comprise recurring service transactions.
11. The methods and systems of clause 10, wherein the future data record recommendation comprises a service future data record for a future service transaction of the recurring service transactions.

Publications cited throughout this document are hereby incorporated by reference in their entirety. While one or more embodiments of the present disclosure have been described, it is understood that these embodiments are illustrative only, and not restrictive, and that many modifications may become apparent to those of ordinary skill in the art, including that various embodiments of the inventive methodologies, the illustrative systems and platforms, and the illustrative devices described herein can be utilized in any combination with each other. Further still, the various steps may be carried out in any desired order (and any desired steps may be added and/or any desired steps may be eliminated).

What is claimed is:

1. A method comprising:
receiving, by at least one processor, data record history comprising a plurality of historical data records associated with a user;
wherein each historical data record of the plurality of historical data records comprises a plurality of data attributes, comprising:
a quantity attribute indicative of a quantity,
a date attribute indicative of a date, and
an entity attribute indicative of a corresponding entity;
utilizing, by the at least one processor, a record pattern machine learning model engine, comprising a record pattern machine learning model of a plurality of trained record pattern parameters, to identify a recurring data record pattern for a particular entity in a whitelist of entities based on the plurality of trained record pattern parameters and the plurality of data attributes of the plurality of historical data records;
wherein the entity attribute matching the particular entity in the whitelist of entities;
wherein the recurring data record pattern comprises a set of recurring data records that repeat with sporadic intervals;
wherein the recurring data record pattern comprises a cadence of recurrence of the quantity attribute and of the entity attribute of each historical data record in the set of recurring data records based on the data attribute of each historical data record in the set of recurring data records;
wherein the cadence of recurrence predicts a regular interval based on the sporadic intervals;
determining, by the at least one processor, the most recent historical data record in the set of recurring data records based on the date attribute of each historical data record in the set of recurring data records;
utilizing, by the at least one processor, a recurrence prediction service, to predict a future data record in the set of recurring data records based at least in part on the cadence of recurrence and the most recent historical data record, the future data record having a future date attribute;
generating, by the at least one processor, a future data record recommendation for at least one future action having an action quantity and action entity that matches the quantity attribute and of the entity attribute of each historical data record in the set of recurring data records;
wherein the future data record recommendation comprises a future data record date associated with the future date attribute;
automatically generating, by the at least one processor, a digital calendar object associated with the entity, wherein the digital calendar object specifies the future data record recommendation; and
automatically inserting, by the at least one processor, the digital calendar object into an electronic calendar associated with the user.

2. The method of claim 1, wherein the plurality of data attributes further comprise a time of day attribute indicative of a time of day;
wherein the recurring data record pattern further comprises a time of day pattern based on the time of day attribute of each historical data record in the set of recurring data records.

3. The method of claim 2, further comprising:
determining, by the at least one processor, an activity associated with each historical data record in the set of recurring data records;
determining, by the at least one processor, an activity length based on the activity; and
determining, by the at least one processor, a scheduled time estimate associated with the set of recurring data records based on the activity length and the time of day pattern.

4. The method of claim 3, further comprising determining, by the at least one processor, an future data record time for the future data record recommendation based on the scheduled time estimate.

5. The method of claim 1, further comprising:
determining, by the at least one processor, a contact method associated with the entity of the entity attribute of each historical data record in the set of recurring data records; and
automatically generating, by the at least one processor, a future data record request via the contact method based on the future data record recommendation.

6. The method of claim 5, wherein the contact method comprises at least one of:
i) a text message,
ii) a telephone call,
iii) an email, or
iv) a combination thereof.

7. The method of claim 1, further comprising:
determining, by the at least one processor, a future data record application programming interface (API) associated with the entity of the entity attribute of each historical data record in the set of recurring data records;
wherein the future data record API enables an automated electronic future data record entry with the entity; and
automatically generating, by the at least one processor, a future data record API request via the future data record API based on the future data record recommendation.

8. The method of claim 1, wherein the plurality of historical data records comprise a history of payment authorizations.

9. The method of claim 1, wherein the set of recurring data records comprise recurring service transactions.

10. The method of claim 9, wherein the future data record recommendation comprises a service future data record for a future service transaction of the recurring service transactions.

11. A system comprising:
at least one processor in communication with a non-transitory memory having software instructions stored thereon, wherein the at least one processor is configured, upon execution of the software instructions, to perform steps to:
receive a data record history comprising a plurality of historical data records associated with a user;
wherein each historical data record of the plurality of historical data records comprises a plurality of data attributes, comprising:
a quantity attribute indicative of a quantity,
a date attribute indicative of a date, and
an entity attribute indicative of an entity;
utilize a record pattern machine learning model engine, comprising a record pattern machine learning model of a plurality of trained record pattern parameters, to identify a recurring data record pattern for a particular entity in a whitelist of entities based on a plurality of the trained record pattern parameters and the plurality of data attributes of the plurality of historical data records;
wherein the entity attribute matching the particular entity in the whitelist of entities;
wherein the recurring data record pattern comprises a set of recurring data records that repeat with sporadic intervals;
wherein the recurring data record pattern comprises a cadence of recurrence of the quantity attribute and of the entity attribute of each historical data record in the set of recurring data records based on the data attribute of each historical data record in the set of recurring data records;
wherein the cadence of recurrence predicts a regular interval based on the sporadic intervals;
determine the most recent historical data record in the set of recurring data records based on the date attribute of each historical data record in the set of recurring data records;
utilizing a recurrence prediction service to predict a future data record in the set of recurring data records based at least in part on the cadence of recurrence and the most recent historical data record, the future data record having a future date attribute;
generate a future data record recommendation for at least one future action having an action quantity and action entity that matches the quantity attribute and of the entity attribute of each historical data record in the set of recurring data records;
wherein the future data record recommendation comprises a future data record date associated with the future date attribute;
automatically generate an electronic event object associated with the entity, wherein the electronic event object specifies a future data record for the user according to the future data record recommendation; and
automatically inserting, by the at least one processor, the electronic event object into an electronic calendar associated with the user.

12. The system of claim 11, wherein the plurality of data attributes further comprise a time of day attribute indicative of a time of day;
wherein the recurring data record pattern further comprises a time of day pattern based on the time of day attribute of each historical data record in the set of recurring data records.

13. The system of claim 12, wherein the at least one processor is further configured, upon execution of the software instructions, to perform steps to:
determine an activity associated with each historical data record in the set of recurring data records;
determine an activity length based on the activity; and
determine a scheduled time estimate associated with the set of recurring data records based on the activity length and the time of day pattern.

14. The system of claim 13, wherein the at least one processor is further configured, upon execution of the software instructions, to perform steps to determine a future data record time for the future data record recommendation based on the scheduled time estimate.

15. The system of claim 11, wherein the at least one processor is further configured, upon execution of the software instructions, to perform steps to:
determine a contact method associated with the entity of the entity attribute of each historical data record in the set of recurring data records; and
automatically generate a future data record request via the contact method based on the future data record recommendation.

16. The system of claim 15, wherein the contact method comprises at least one of:
i) a text message,
ii) a telephone call,
iii) an email, or
iv) a combination thereof.

17. The system of claim 11, wherein the at least one processor is further configured, upon execution of the software instructions, to perform steps to:
determine a future data record application programming interface (API) associated with the entity of the entity attribute of each historical data record in the set of recurring data records;
wherein the future data record API enables an automated electronic future data record entry with the entity; and
automatically generate a future data record API request via the future data record API based on the future data record recommendation.

18. The system of claim 11, wherein the plurality of historical data records comprise a history of payment authorizations.

19. The system of claim 11, wherein the set of recurring data records comprise recurring service transactions.

20. The system of claim 19, wherein the future data record recommendation comprises a service future data record for a future service transaction of the recurring service transactions.
